(19) United States
(12) Patent Application Publication
(10) Pub. No.: US 2009/0057239 A1
(43) Pub. Date: Mar. 5, 2009

(54) METHOD AND APPARATUS FOR WATER DISTRIBUTION

(76) Inventor: Robert E. Walker, Mercer Island, WA (US)

Correspondence Address: MOORE & VAN ALLEN PLLC, P.O. BOX 13706, Research Triangle Park, NC, 27709, US

(21) Appl. No.: 12/173,652

(22) Filed: Jul. 15, 2008

Related U.S. Application Data
(60) Provisional application No. 60/950,024, filed on Jul. 16, 2007.

(51) Int. Cl. C02F 1/02; C02F 103/04

(52) U.S. Cl. 210/742; 210/195.1; 210/172.1; 210/181; 210/137; 210/774

(57) ABSTRACT

A water distribution apparatus comprises a water user outlet facility and a water recirculation loop. The water re-circulation loop comprises a water supply, a water pump for establishing and maintaining a flow of water in the loop, a water delivery path extending from the pump to a water user outlet facility, a water return path extending from the water user outlet facility to the water supply, and a thermal disinfection apparatus disposed in the water delivery path for improving the potability of the water within the loop. A thermal heating apparatus and control is provided in the water delivery path or water storage tank to add thermal energy to prevent freezing of the stored water as well as the water flowing in the water re-circulation loop.

### BACKGROUND

The invention relates generally to an apparatus and method for water distribution, and more particularly to an apparatus and method for water distribution for use in mobile applications.

Most water distribution systems are once-through systems wherein water is dispensed from a water tank to a user outlet facility, including taps, faucets, bidets, toilets, coffee makers, dishwashers, etc., but only when user demand occurs. The path of water flow between a water supply and the user outlet facility may include devices such as screens, filters, water purifiers, or the like, that are designed to improve the inorganic quality of water passing through them.

Some water distribution systems may also include a means for re-circulating stored water for the purpose of preventing stagnation by aeration of the water and to desensitize the water distribution system to environmental temperature extremes. Such systems include those described in U.S. Pat. No. 6,463,956 B2, entitled “Method of Water Distribution and Apparatus Therefor”, which issued Oct. 5, 2002; U.S. Pat. No. 6,766,822, entitled “Method of Water Distribution and Apparatus Therefor”, which issued Jul. 27, 2004; and U.S. patent application Ser. No. 11/780,659 entitled “Method and Apparatus for Water Distribution”, which was filed Jul. 20, 2007, the contents of all which are hereby incorporated by reference in their entirety.

Current re-circulating potable water systems, while they are effective in improving the bio-quality and preventing freezing of the water in the system, can cause the water temperature at the user outlet facilities to become too warm for some usage. This problem is amplified in some mobile applications, such as aircraft, wherein the potable water systems are required to function in widely varying environments. In a cold environment, re-circulating potable water systems add heat to the stored water by means of the energy applied to water as the water passes through the pump, and the various forms of disinfection that consume power in their process of disinfecting the water that flows through them. However, apparatus that is properly designed to prevent freezing of the water in the system when exposed to the cold environment can create excessive temperatures in the stored water when operating in a high temperature environment.

For the foregoing reasons, there is the need for a new apparatus and method for potable water distribution that minimizes the range of the re-circulating water temperature as the environmental temperatures vary.

### SUMMARY

According to the present invention, a water distribution apparatus is provided, comprising a water user outlet facility including a water inlet port, a water outlet port and a water outlet path extending from the water inlet port to the water outlet port, and a water re-circulation loop. The water re-circulation loop includes a water supply, a water pump in water flow communication with the water supply for establishing and maintaining a flow of water in the loop, a water delivery path extending from the pump to the water user outlet facility, at least one water return path to the water supply, and an exothermic disinfection apparatus disposed in the water delivery path for improving the potability of the water within the loop.

In one aspect, the disinfection apparatus comprises an ultraviolet radiant lamp, or other such device, for adding heat to the water flowing through the apparatus. These exothermic devices are operated for a time period sufficient to have the quantity of stored water in the tank re-cycled through the disinfection apparatus such that at least 99% of the stored water will have been exposed to the biocidal treatment of the disinfection apparatus, at which time the disinfection unit can be inactivated and allowed to become dormant. If the environmental conditions cause the water temperature to approach the freezing temperature, then the disinfection unit is re-energized and the heat from the exothermic device maintains the water temperature at or above the freezing temperature.

In a second aspect, the water pump has a dual speed motor. The pump is operated at the normal speed for all but very cold environmental operating conditions. When, during cold environmental conditions, the water temperature approaches the freezing point, the pump is commanded to operate at the high speed condition. This condition causes added energy to be consumed by the pump, thereby providing more heat, some of which is transferred to the water flowing through the pump. This results in a sufficient rise of water temperature to prevent the water in the system from freezing.

In a third aspect, at least a portion of the water distribution lines are covered with a heater blanket that is thermostatically controlled by temperature sensors that energize the heating elements contained in the blanket. Thus the electrical energy dissipated in the blanket is partially transferred to the water lines and then into the water, thereby maintaining the water temperature at or above the freezing temperature during cold operations.

In a fourth aspect, the water distribution lines have inserted within them heater wires that are thermostatically controlled by temperature sensors that energize the heater wires, which in turn warm the water maintaining the water temperature at or above the freezing temperature during cold operations.

In a fifth aspect, the water supply is a water storage tank. Embedded within the storage tank is an electrical heater controlled by a thermostat also mounted in the water tank to control the energy supplied to the heater, thereby maintaining the water temperature in the tank at a minimum temperature determined to prevent freezing of the water in the lines of the distribution loop.

In a sixth aspect, embedded within the water storage tank is an ultraviolet disinfection unit controlled by a thermostat also mounted in the tank to control the energy supplied to the UV unit, thereby maintaining the water temperature in the tank at a minimum temperature determined to prevent freezing of the water in the lines of the distribution loop.

### BRIEF DESCRIPTION OF THE DRAWINGS

For a more complete understanding of the present invention, reference should now be made to the embodiments shown in the accompanying drawings and described below. In the drawings:

FIG. 1 is a schematic view of an embodiment of a water distribution system according to the present invention.

FIG. 2 is a schematic view of another embodiment of a water distribution system according to the present invention.

FIG. 3 is a schematic view of another embodiment of a water distribution system according to the present invention including an external heating blanket.

FIG. 4 is a schematic view of another embodiment of a water distribution system according to the present invention including an internal electrical heating element.

FIG. 5 is a schematic view of another embodiment of a water distribution system according to the present invention including an electric heating element installed within the water storage tank.

FIG. 6 is a schematic view of another embodiment of a water distribution system according to the present invention including an ultra violet disinfection unit installed within the water storage tank.

### DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

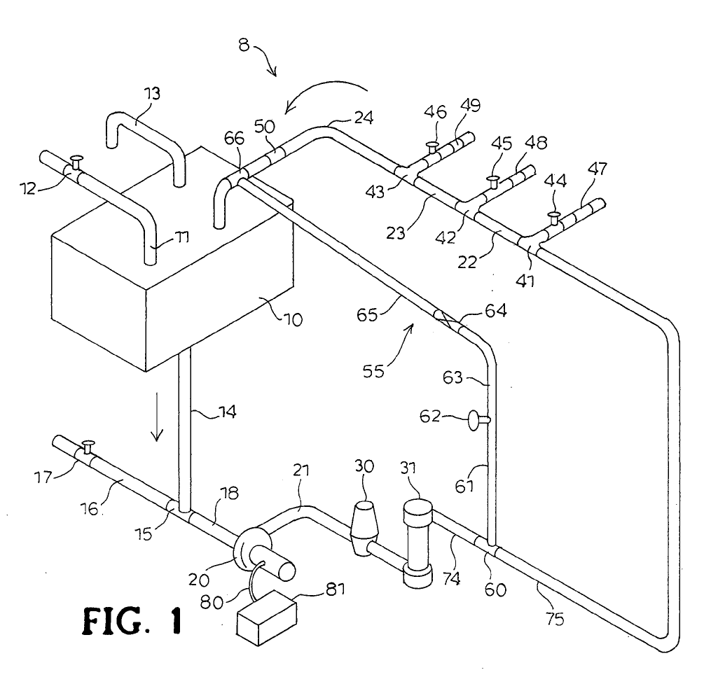

Referring now to the drawings, wherein like reference numerals designate corresponding or similar elements throughout the several views, an embodiment of a water distribution system according to the present invention is shown in FIG. 1 and generally designated at 8. Generally, FIG. 1 is a schematic view of an embodiment of a water distribution system 8 according to the present invention comprising a water storage tank 10 and a water return branch line 61 for recycling the majority of the water flow passing through an upstream disinfection unit 31 back to the storage tank 10.

The water storage tank 10 is initially filled with water through a water inlet line 11 from an external source (not shown). The quantity of water added to the system is controlled by the use of a valve 12. The tank 10 also includes an air inlet vent 13 that serves to equalize pressure in the tank with that of the surrounding environment by allowing air from the surrounding environment to enter into and exhaust from the tank through a filter (not shown) that forms part of the inlet path. Stored water is drawn from the tank 10 through a discharge pipe 14 that leads through a T-connection 15 to a drain pipe 16. The drain pipe 16 includes a valve 17 that is normally closed to prevent drainage, but which may be opened when it is desired to empty the tank 10 and the system. The T-connection 15 also connects to a delivery pipe 18, which supplies the stored water to a pump 20. In the FIGs., the pump 20 is schematically depicted as being connected by an electrical cable 80 to an electrical power source 81. For mobile applications, the source 81 may be considered as representative of the on-board electrical system of an aircraft, train, bus, or recreational vehicle. The pump 20 discharges into a distribution pipe 21 that leads firstly to a water filter 30 that serves to remove particulate matter, i.e. ions of chlorine and minerals and miscellaneous inorganic materials, then to a typical water disinfection unit 31 such as a lamp source that irradiates the flowing water with ultraviolet radiation to kill or neuter organic contaminants. The water disinfection unit 31 can also be a thermal energy contributing device that firstly exposes the water borne bio-contaminants to temperatures of about 150° F. to neutralize or degrade the bio-materials contained in the water flow, and secondarily returns the water flow back to its inlet temperature.

The water disinfection unit 31 discharges into a distribution pipe 74 that leads through a T-connection 60 to a return branch line 55, which provides a return path of cleaned and purified water back to the water storage tank 10. In the return branch line 55, from the T-connection 60 the water flows in a pipe 61 to a shut-off valve 62 and then on to a pipe 63 that attaches to a flow-limiting device, such as an orifice 64. The flow-limiting device 64 controls the flow from the pump 20 at the maximum value prescribed by the performance limitations of the water disinfection unit 31. From the flow control device 64, the flow proceeds through a pipe 65 to a connection 66 inserted in a water return pipe 24 attached to the top of the water storage tank 10. The return branch line 55 allows water to by-pass a portion of the water distribution system 8 and be returned back to the water storage tank 10 after the water has passed through water purification equipment.

This feature provides a method of purifying the stored water supply for potable usage prior to delivering the water to the water user outlet facilities 41, 42, 43. Moreover, the water distribution system 8 can continue to deliver all of the stored potable quality water to the water user outlet facilities 41, 42, 43 in the event that the disinfection unit 31 fails before delivery of the stored water, if the unit has operated for a time period and at a flow rate, the product of which, represents several total recycles of the stored water.

Returning to the T-connection 60 and the water flow supplying the water distribution path, the water available for delivery to the water user outlet facilities flows through a pipe 75 to the first of one or more water user outlet facilities, shown as 41, 42,43, that are interconnected in succession by pipe segments 22, 23. Each outlet facility 41,42, 43 includes an associated tap valve 44, 45, 46 controllable by the water users, and an associated non-return valve (check valve) 47, 48, 49. The water return pipe 24 leads from the last of the three representative water user outlet facilities 41, 42, 43 to a flow controlling device 50 and then into the water storage tank 10.

Thermal protection of the water in the water distribution system 8 shown in FIG. 1 during cold environmental conditions is provided by the activation of the disinfection unit 31 when the water in the system approaches freezing temperature. The disinfection unit 31 may be de-activated until thermal energy is needed to prevent freezing of the water supply lines and tank-stored water. Moreover, the water distribution system 8 incorporates a short-circuiting loop of water lines that allows a rapid bio-cleaning of the water supply.

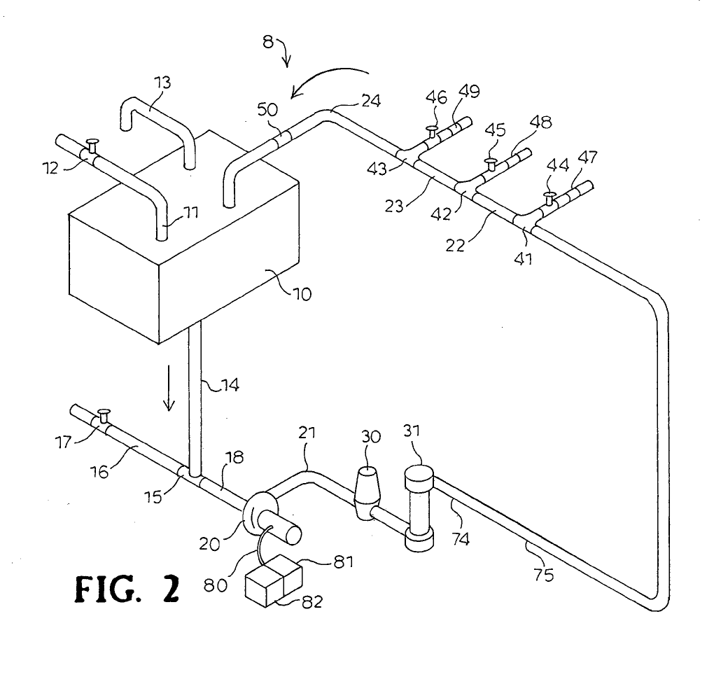

Another embodiment of a water distribution system 8 according to the present invention is shown in FIG. 2, which depicts a dual power control unit 81, 82 for controlling the input energy level for operation of a dual speed pump 26. In normal operation the control unit 81, 82 operates the pump 26 to supply ample pressure for the flow of water in the distribution loop for normal flow rates. When more flow is required, such as for purging or draining of the water distribution system, or when more thermal energy is needed to prevent freezing of water, the control unit 81, 82 is programmed to operate the pump 26 in a high energy (speed) mode. At high speed, the dual speed pump 26 operation will provide additional energy into the water distribution system 8 to prevent freezing of the water supply lines and tank-stored water.

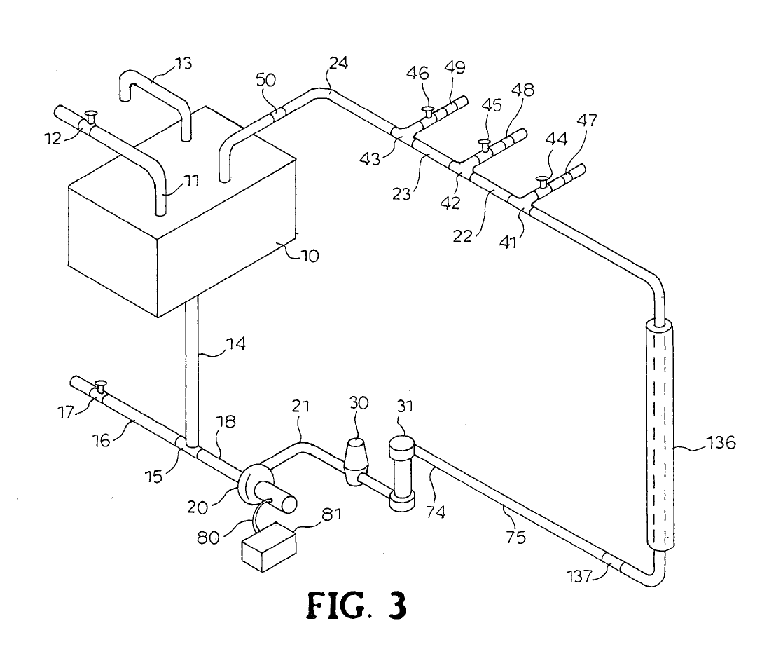

Another embodiment of a water distribution system 8 according to the present invention is shown in FIG. 3, which depicts an external electric blanket 136 covering a portion of the water line 75 and an upstream thermostatic control device 137. In use, the electric blanket 136 is electrically heated to add additional thermal energy to the water distribution system 8 when necessary to prevent freezing of the water in the water supply lines and tank-stored water.

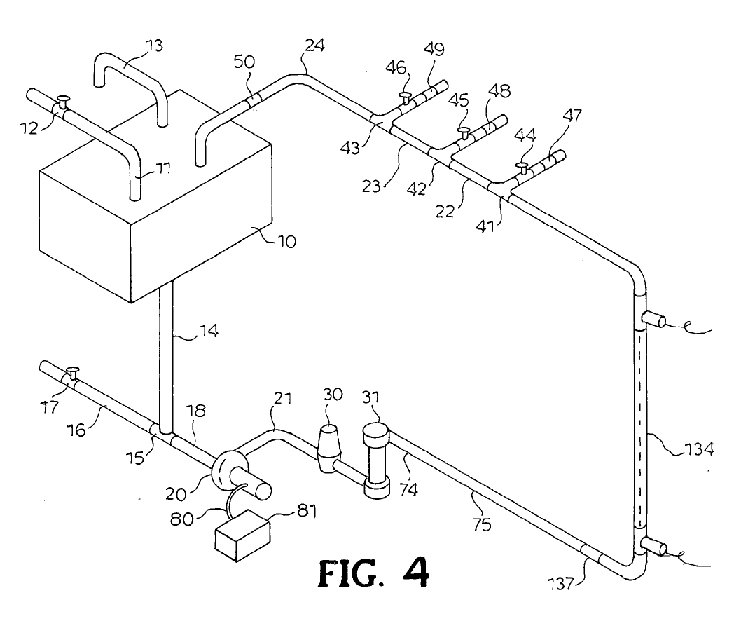

Another embodiment of a water distribution system 8 according to the present invention is shown in FIG. 4, which depicts an internal electrical heating element 134 inserted into the water line 75 downstream of the thermostatic control device 137. The heating element 134 is controlled to add additional thermal energy to the water distribution system 8 when necessary to prevent freezing of the water in the water supply lines and tank-stored water.

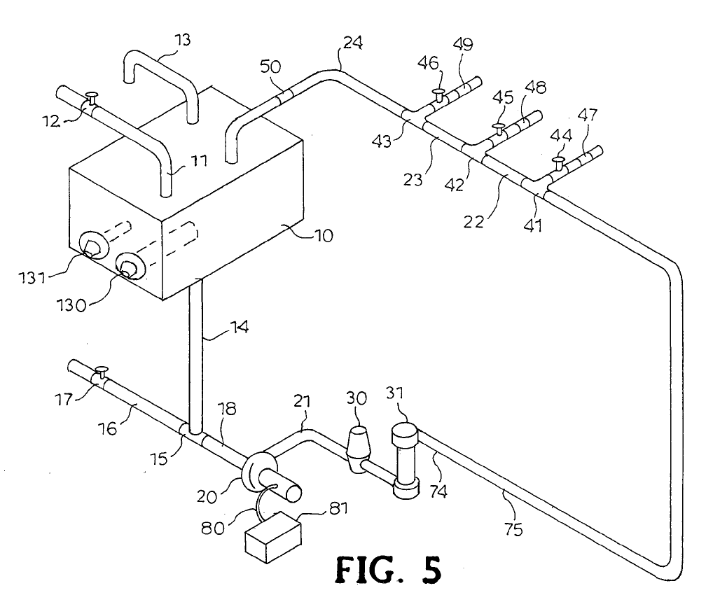

Another embodiment of a water distribution system 8 according to the present invention is shown in FIG. 5, which depicts a water heater unit 130 incorporated in the water storage tank 10. The heater unit 130 is activated by a thermostatic type control sensor 131 when the temperature of the water in the water storage tank 10 drops to a temperature equal to the freezing temperature plus an analytically predetermined temperature developed by an analytical evaluation of the installed configuration of the system and the magnitude of temperature variance of the operational environment to which the water distribution lines are exposed. The analytical evaluation is within the knowledge of a person of ordinary skill in the art of fluid flow and thermodynamics.

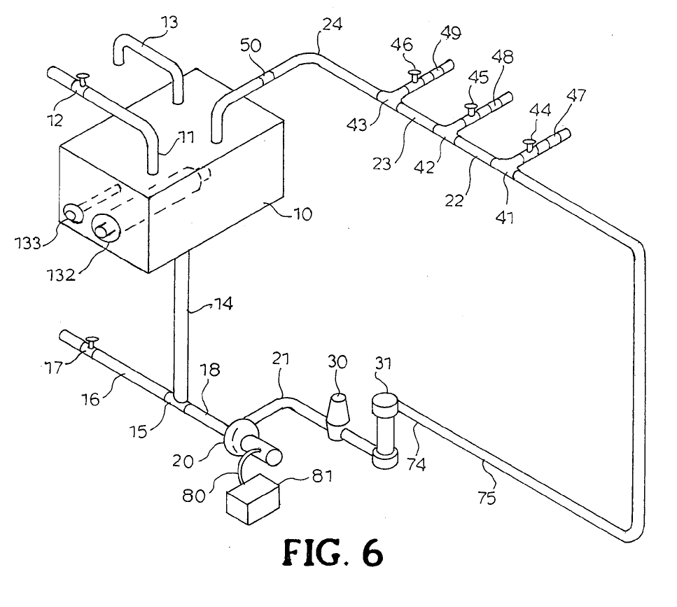

Another embodiment of a water distribution system 8 according to the present invention is shown in FIG. 6, which depicts an exothermic disinfection unit 132 incorporated in the water storage tank 10. In use, the exothermic disinfection unit 132 unit is automatically activated whenever water is added to the water storage tank 10. Alternatively, a thermostat 133 may be mounted on the water storage tank 10. When the temperature of the water in the water storage tank 10 drops to a temperature equal to the freezing temperature plus an analytically predetermined temperature developed by the analytical evaluation of the installed configuration of the system and the magnitude of temperature variance of the operational environment to which the water distribution lines are exposed. As noted above, the analytical evaluation is within the knowledge of a person of ordinary skill in the art of fluid flow and thermodynamics. The thermostat 133 will activate the disinfection unit 132 to add thermal energy to the stored water, raising the temperature to prevent freezing of the stored water as well as the water flowing in the water delivery circuit.

Although the present invention has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. For example, the water distribution may be used in a number of applications where potable water is to be delivered to a user. Accordingly, I intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

I claim:

1. A water distribution apparatus, comprising:
(a) a water user outlet facility including a water inlet port, a water outlet port, and a water outlet path extending from the water inlet port to the water outlet port; and
(b) a water re-circulation loop, comprising
(i) a water supply,
(ii) a water pump in water flow communication with the water supply for establishing and maintaining a flow of water in the loop,
(iii) a water delivery path extending from the pump to the water user outlet facility,
(iv) a first water return path extending from the water user outlet facility to the water supply,
(v) at least one water treatment device for improving the potability of the water within the loop, and
(vi) a second water return path extending from the water delivery path between the pump and the water supply.

2. A water distribution apparatus as recited in claim 1, wherein the at least one water treatment device is positioned in the water delivery path.

3. A water distribution apparatus as recited in claim 1, wherein the water supply comprises a water storage tank.

4. A water distribution apparatus as recited in claim 1, wherein the water storage tank is positioned between the water user outlet facility and the pump and comprises a portion of the return path.

5. A water distribution apparatus as recited in claim 1, wherein the second water return path extends from the water delivery path between at least one water treatment device and the water user outlet facility to the water supply.

6. A water distribution apparatus as recited in claim 1, wherein the water re-circulation loop is self-contained.

7. A water distribution apparatus as recited in claim 6, wherein the water re-circulation loop comprises a portion of a water supply system carried on board a vehicle.

8. A water distribution apparatus as recited in claim 7, wherein the vehicle is an aircraft, train bus, boat or recreational vehicle.

9. A water distribution apparatus as recited in claim 2, wherein the water treatment device located in the distribution lines can be activated to add additional heat to the water to prevent freezing in the system.

10. A water distribution apparatus as recited in claim 3, wherein the water treatment device located in the water storage tank can be activated to add additional heat to the water to prevent freezing in the system.

11. A water distribution apparatus, comprising:
(a) a water user outlet facility including a water inlet port, a water outlet port, and a water outlet path extending from the water inlet port to the water outlet port;
(b) a water re-circulation loop, comprising
(i) a water supply,
(ii) a water pump in water flow communication with the water supply for establishing and maintaining a flow of water in the loop,
(iii) a water delivery path extending from the pump to the water user outlet facility, wherein the water inlet port is in water flow communication with the water delivery path,
(iv) a water return path extending from the water user outlet facility to the water supply, and
(v) at least one water treatment device for improving the potability of the water within the loop; and
(c) a tap valve disposed in the water outlet path and controllable by a water user to tap a portion of the flow from the water delivery path through the water outlet path while the water user outlet facility directs a remaining portion of the flow into the water return path.

12. A water distribution apparatus as recited in claim 11, wherein the water supply comprises a water storage tank.

13. A water distribution apparatus as recited in claim 12, wherein the water storage tank is positioned between the water user outlet facility and the pump and comprises a portion of the water return path.

14. A water distribution apparatus as recited in claim 11, wherein the water re-circulation loop is self-contained.

15. A water distribution apparatus as recited in claim 14, wherein the water re-circulation loop comprises a portion of a water supply system carried on board a vehicle.

16. A water distribution apparatus as recited in claim 15, wherein the vehicle is an aircraft, train, bus, boat or recreational vehicle.

17. A water distribution apparatus as recited in claim 11, wherein the pump is a dual powered unit. While operating on high power it increases the energy transferred to the water flowing through it, thus adding sufficient heat to prevent the system's water supply from freezing.

18. A water distribution apparatus, comprising:
(a) a water user outlet facility including a water inlet port, a water outlet port, and a water outlet path extending from the water inlet port to the water outlet port; and
(b) a water re-circulation loop, comprising
(i) a water supply,
(ii) a water pump in water flow communication with the water supply for establishing and maintaining a flow of water in the loop,
(iii) a water delivery path extending from the pump to the water user outlet facility, and
(iv) a water return path extending from the water user outlet facility to the water supply.

19. A water distribution apparatus as recited in claim 18, wherein the water supply comprises a water storage tank.

20. A water distribution apparatus as recited in claim 19, wherein the water storage tank is positioned between the water user outlet facility and the pump and comprises a portion of the water return path.

21. A water distribution apparatus as recited in claim 18, wherein the water re-circulation loop is self-contained.

22. A water distribution apparatus as recited in claim 18, wherein the water re-circulation loop comprises a portion of a water supply system carried on board a vehicle.

23. A water distribution apparatus as recited in claim 22, wherein the vehicle is an aircraft, train, bus, boat or recreational vehicle.

24. A water distribution apparatus as recited in claim 18, wherein the distribution lines are covered by electrically heated blankets that are activated by a thermostatic control, to provide additional heating to prevent water freezing in the distribution lines.

25. A water distribution apparatus as recited in claim 18, wherein the distribution lines have inserted within them electrically heated elements that are activated by a thermostatic control, to provide additional heating to prevent water freezing in the distribution lines.

26. A method of supplying water to a water user outlet facility, the water supplying method comprising:
(a) directing a tappable flow of water in a water re-circulation loop, the loop including
(i) a water pump for establishing and maintaining the flow of water in the loop,
(ii) a water delivery path extending from the pump to the water user outlet facility,
(iii) a water return path extending from the water user outlet facility to the pump, and
(iv) at least one water treatment device for improving the potability of water within the loop; and
(b) heating the water in the water delivery path to a predetermined temperature and for a predetermined period of time, the product of which, is sufficient to degrade targeted biomaterials thereby improving the potability of the water within the loop.

27. A water supplying method as recited in claim 26, wherein the step of directing a tappable flow of water in a water re-circulation loop comprises providing a tappable flow of water from an external water source.

28. A water supplying method as recited in claim 26, wherein the water return path comprises a water storage tank.

29. A water supplying method as recited in claim 26, wherein the predetermined temperature is at least 150° F.

30. A water supplying method as recited in claim 26, wherein the water return path comprises a water storage tank in which is installed an electrical heating element, activated by a thermostatic control to provide additional heating to prevent water from freezing in the tank and the distribution lines.
